(19) United States
(12) Patent Application Publication
(10) Pub. No.: US 2018/0336591 A1
(43) Pub. Date: Nov. 22, 2018

(54) Virtually projected augmented ad display

(71) Applicant: Philip Neumeier, Pinckney, MI (US)

(72) Inventor: Philip Neumeier, Pinckney, MI (US)

(21) Appl. No.: 15/595,951

(22) Filed: May 16, 2017

(51) Int. Cl. G06Q 30/02; G06T 11/60

(52) U.S. Cl. CPC G06Q 30/0261; G06T 11/60

(57) ABSTRACT

This disclosure relates generally to augmented reality devices and systems and, in particular, to an advertising system and method for such devices and systems. Using Geographic location and Accelerometer Sensors for ad placement. One can virtually view advertisements in real time that appear digitally while in virtual augmented environments. It allows virtual ads to be placed on objects while in augmented reality. A user will simply turn on the screen or phone and uses it while in augmented reality and then using that user's location and accelerometer an advertisement will appear in real time.

### BACKGROUND

### Field of the Invention

The present invention relates to using Geographic location and Accelerometer Sensors for ad placement. One can virtually view advertisements in real time that appear digitally while in virtual augmented environments.

Aspects of the present invention relate more particularly to the advertisers to market in augmented reality with virtual advertisements.

### Description of the Related Art

An augmented reality (AR) technology, which may include a head-mounted display (HMD), may allow a user to view a real-world scene while also viewing and/or interacting with one or more virtual objects (e.g., text, graphics) displayed to the user by the HMD of the AR device. An HMD of an AR device may be in the form of goggles or glasses. For example, AR glasses may use a camera to capture images of a real-world scene being viewed by the user of the AR device and provide information relevant to the real-world scene and/or information with which a user is interested in interacting.

Due to AR devices being electronic, an AR device requires a power source in order to power its components (such as the HMD of the AR glasses, a processor, and/or a wireless interface). Since AR devices may be intended to be mobile and worn by a user while everyday tasks are being performed, one or more batteries may be used to power AR devices such that the user is not tethered to a power outlet or other form of power source. To have sufficient power to operate an AR device for a reasonable amount of time, batteries may need to be present in the AR device that make the AR device larger, heavier, and/or more expensive than if the batteries were reduced in size, complexity, and/or capacity.

However, to Applicant's knowledge, None of these prior art devices has been found to be completely suitable to meet this need. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

According to a first embodiment using Geographic location and Accelerometer Sensors for ad placement. One can virtually view advertisements in real time that appear digitally while in virtual augmented environments. It allows virtual ads to be placed on objects while in augmented reality,

Another object of the invention relates to advertisers to market in augmented reality with virtual advertisements.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows the one embodiment of augmented reality ad display through IPad.

FIG. 2 shows augmented reality ad display through a mobile phone.

FIG. 3 shows augmented reality ad display through goggles.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Considering the advances in technology, this invention relates to allows advertisers to market in augmented reality with virtual advertisements. The advertisements are viewed by another person through an augmented reality apparatus, such as virtual reality Goggles. The use of these techniques can provide benefits for the persons using the virtual individual advertisement space, for those viewing the advertising space, and for those wishing for unique ways in which to advertise.

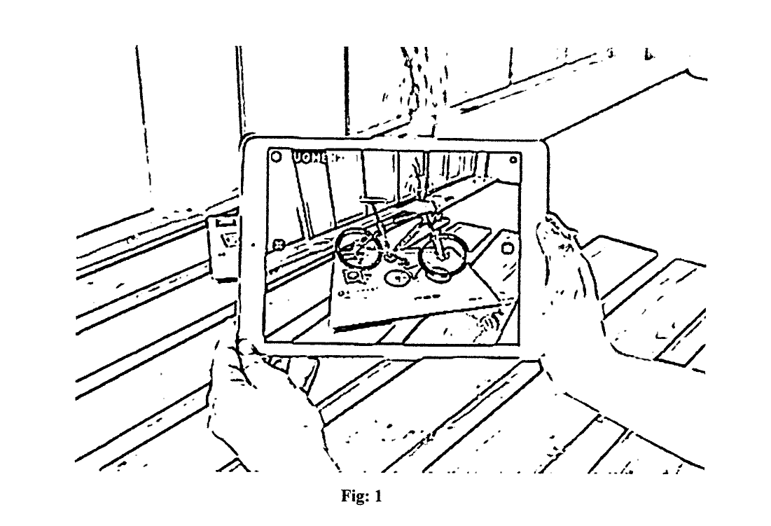

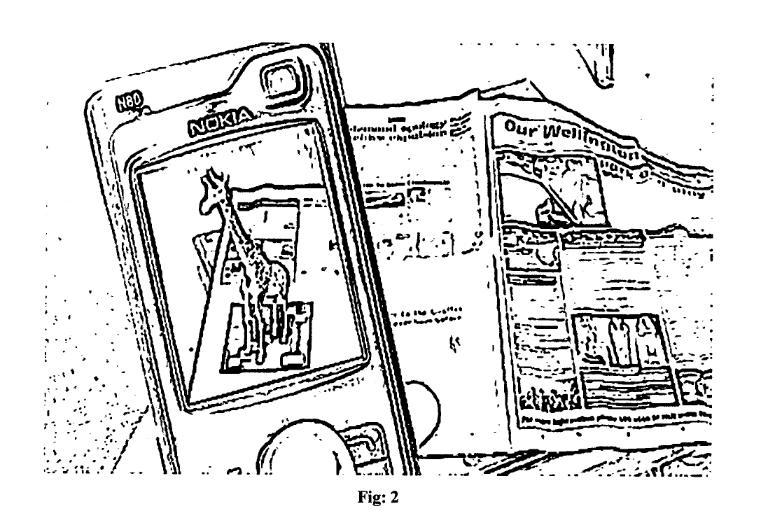

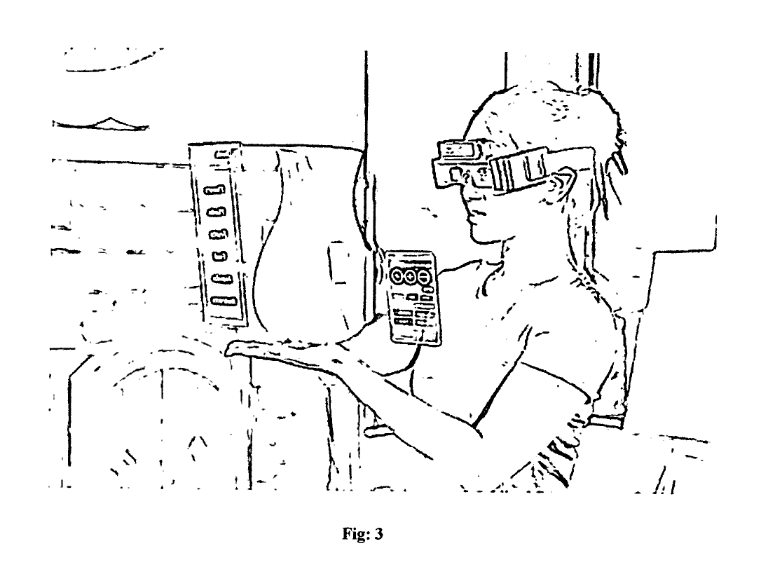

FIG. 1 shows one embodiment of augmented reality advertisement where a user uses IPad to see an advertisement. FIG. 2 and FIG. 3 in similar fashion shows advertisement on mobile and through goggles.

The functionality will be simple and easy for the user. A user will simply turns on the screen or phone and uses it while in augmented reality and then use that user's location and accelerometer an advertisement will appear in real time.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. The present invention is a system of advertising on an augmented reality to a user comprising:
1) A processing device i.e. goggles, mobile adapted to communicate with the augmented reality device and a network; and,
2) Receiving, generating and transmitting the advertisement to the augmented reality device for viewing by the user.
